(19) United States
(12) Patent Application Publication
(10) Pub. No.: US 2023/0342847 A1
(43) Pub. Date: Oct. 26, 2023

(54) EXECUTION METHOD AND INFORMATION PROCESSING APPARATUS

(71) Applicant: Fujitsu Limited, Kawasaki-shi (JP)

(72) Inventor: Toshihiro Shimizu, Kawasaki (JP)

(73) Assignee: Fujitsu Limited, Kawasaki-shi (JP)

(21) Appl. No.: 18/101,828

(22) Filed: Jan. 26, 2023

(30) Foreign Application Priority Data
Apr. 26, 2022 (JP) 2022-072322

(51) Int. Cl. G06Q 40/04

(52) U.S. Cl. CPC G06Q 40/04

(57) ABSTRACT

According to an aspect of the embodiment, a non-transitory computer-readable recording medium stores a program for causing a computer to execute a process, the process includes generating a first graph which has a plurality of nodes and in which a lower limit constraint and a first upper limit constraint are set to an edge that connects each node, generating a second graph by reducing the lower limit constraint and the first upper limit constraint set in the first graph to a second upper limit constraint only, setting a flow rate on each edge in the second graph by solving a maximum flow problem of the second graph, converting the flow rate set to each edge in the second graph into a flow rate set to each edge in the first graph, and identifying an execution price based on the flow rate set to each edge in the first graph.

### CROSS-REFERENCE TO RELATED APPLICATION

This application is based upon and claims the benefit of priority of the prior Japanese Pat. Application No. 2022-72322, filed on Apr. 26, 2022, the entire contents of which are incorporated herein by reference.

### FIELD

The embodiment discussed herein is related to an execution method and an information processing apparatus.

### BACKGROUND

In a securities market, establishment of a trade such as stock trading is referred to as “execution”. For example, a state where a condition of a user who has placed a sell order matches a condition of a user who has placed a buy order and transaction has been closed is referred to as an execution. In a case where a user places an order (sell order or buy order), there is a case where an order is placed under conditions such as a full-volume execution or a certain number of execution quantity.

Here, description will be given assuming a market in which a full-volume execution order that designates a price is placed in the securities market. For example, a sell order and a buy order are matched so as to satisfy the following conditions (1) to (3) and maximize the execution quantity.

Condition (1): the designated number of stocks must be executed (full-volume execution).

Condition (2): In the case of a sell order, a designated price or more is passed.

Condition (3): In the case of a buy order, a designated price or less is received.

FIG. 10 is a diagram illustrating matching between sell orders and buy orders. In the example illustrated in FIG. 10, orders Or1, Or2, Or3, Or4, and Or5 exist as sell orders. The order Or1 is an order of which the number of orders is “3” and the designated price is “6”. The order Or2 is an order of which the number of orders is “2” and the designated price is “5”. The order Or3 is an order of which the number of orders is “5” and the designated price is “12”. The order Or4 is an order of which the number of orders is “3” and the designated price is “7”. The order Or5 is an order of which the number of orders is “4” and the designated price is “13”.

On the other hand, orders Or6, Or7, and Or8 exist as buy orders. The order Or6 is an order of which the number of orders is “4” and the designated price is “8”. The order Or7 is an order of which the number of orders is “2” and the designated price is “5”. The order Or8 is an order of which the number of orders is “6” and the designated price is “17”.

For example, when the orders Or1 to Or5 are matched with the orders Or6 to Or8 so as to satisfy the conditions (1) to (3) and maximize the execution quantity, the orders Or1 to Or3 and the orders Or6 and Or8 are executed. The total number of orders of the orders Or1 to Or3 is “10”, and the total number of orders of the orders Or6 and Or8 is “10”. Furthermore, the total designated price of the orders Or1 to Or3 is “23”, and the total designated price of the orders Or6 and Or8 is “25”.

Note that, in the case of the full-volume execution, a knapsack problem is formed. Therefore, it is difficult to solve the problem unless some conditions are set.

Here, as an existing technology that matches sell orders and buy orders, there is a solution by dynamic programming. FIGS. 11 to 16 are diagrams illustrating the existing technology. In the following description, a device that executes the existing technology will be referred to as an “existing device” for convenience. The existing device sets an array a, and in a case where a[i] < ∞ and an order of which the number of orders is x and a price is p is arrived, when a[i + x] > a[i] + p, the existing device sets a[i + x] = a[i] + p (update when a value of an element decreases).

In FIGS. 11 and 12, update of the array a in a case where the existing device accepts a “sell order” is indicated. FIG. 11 will be described. It is assumed that an initial state of the array a is as indicated in Step S50. In the initial state of the array a, a[0] = 0, and all other elements are set to “∞”.

In a case where a sell order of which the number of orders is three and a price is six (ten thousand yen, omitted below) is accepted, the state of the array a is as indicated in Step S51. Because the array a[0 + 3] = ∞ and a[0] + p = 6, the array a[0 + 3] > a[0] + p. Therefore, the existing device sets the array a[0 + 3] = 6.

In a case where a sell order of which the number of orders is two and a price is five is accepted, the state of the array a is as indicated in Step S52. Because the array a[0 + 2] = ∞ and a[0] + p = 5, the array a[0 + 2] > a[0] + p. Therefore, the existing device sets the array a[0 + 2] = 5. Because the array a[3 + 2] = ∞ and a[3] + p = 11, the array a[3 + 2] > a[3] + p. Therefore, the existing device sets the array a[3 + 2] = 11.

The description proceeds to FIG. 12. In a case where a sell order of which the number of orders is five and a price is 12 is accepted, the state of the array a is as indicated in Step S53. Because the array a[0 + 5] = 11 and a[0] + p = 12, the array a[0 + 5] < a[0] + p. Therefore, the existing device maintains the array a[0 + 5] = 11 (does not update).

Because the array a[2 + 5] = ∞ and a[2] + p = 17, the array a[2 + 5] > a[2] + p. Therefore, the existing device sets the array a[2 + 5] = 17. Because the array a[3 + 5] = ∞ and a[3] + p = 18, the array a[3 + 5] > a[3] + p. Therefore, the existing device sets the array a[3 + 5] = 18.

Because the array a[5 + 5] = ∞ and a[5] + p = 13, the array a[5 + 5] > a[5] + p. Therefore, the existing device sets the array a[5 + 5] = 23.

In a case where a sell order of which the number of orders is three and a price is seven is accepted, the state of the array a is as indicated in Step S54. Because the array a[0 + 3] = 6 and a[0] + p = 7, the array a[0 + 3] < a[0] + p. Therefore, the existing device maintains the array a[0 + 3] = 6 (does not update). Because the array a[2 + 3] = 11 and a[2] + p = 12, the array a[2 + 3] < a[2] + p. Therefore, the existing device maintains the array a[2 + 3] = 11 (does not update).

Because the array a[3 + 3] = ∞ and a[3] + p = 13, the array a[3 + 3] > a[3] + p. Therefore, the existing device sets the array a[3 + 3] = 13. Because the array a[3 + 5] = 18 and a[5] + p = 18, the array a[3 + 5] = a[5] + p. Therefore, the existing device maintains the array a[3 + 5] = 18 (does not update).

Because the array a[7 + 3] = 23 and a[7] + p = 24, the array a[7 + 3] < a[7] + p. Therefore, the existing device maintains the array a[7 + 3] = 13 (does not update). Because the array a[8 + 3] = ∞ and a[8] + p = 25, the array a[8 + 3] > a[8] + p. Therefore, the existing device sets the array a[8 + 3] = 25.

In a case where a sell order of which the number of orders is four and a price is 13 is accepted, the state of the array a is as indicated in Step S55. Because the array a[0 + 4] = ∞ and a[0] + p = 13, the array a[0 + 4] > a[0] + p. Therefore, the existing device sets the array a[0 + 4] = 13. Because the array a[2 + 4] = 13 and a[2] + p = 18, the array a[2 + 4] < a[2] + p. Therefore, the existing device maintains the array a[2 + 4] = 13 (does not update).

Because the array a[3 + 4] = 17 and a[3] + p = 19, the array a[3 + 4] < a[3] + p. Therefore, the existing device maintains the array a[3 + 4] = 17 (does not update). Because the array a[5 + 4] = ∞ and a[5] + p = 24, the array a[5 + 4] > a[5] + p. Therefore, the existing device sets the array a[5 + 4] = 24.

Because the array a[6 + 4] = 23 and a[6] + p = 24, the array a[6 + 4] < a[6] + p. Therefore, the existing device maintains the array a[6 + 4] = 23 (does not update). Because the array a[7 + 4] = 25 and a[7] + p = 28, the array a[7 + 4] < a[7] + p. Therefore, the existing device maintains the array a[7 + 4] = 25 (does not update).

Because the array a[8 + 4] = ∞ and a[8] + p = 31, the array a[8 + 4] > a[8] + p. Therefore, the existing device sets the array a[8 + 4] = 31. Because the array a[10 + 4] = ∞ and a[10] + p = 36, the array a[10 + 4] > a[10] + p. Therefore, the existing device sets the array a[10 + 4] = 36. Because the array a[11 + 4] = ∞ and a[11] + p = 38, the array a[11 + 4] > a[11] + p. Therefore, the existing device sets the array a[11 + 4] = 38.

Subsequently, the description proceeds to FIG. 13. In FIG. 13, update of an array b in a case where the existing device accepts a buy order is indicated. The existing device sets the array b, and in a case where b[i] > -∞ and an order with the number of orders is x and a price is p is arrived, when b[i + x] < b[i] + p, sets b[i + x] = b[i] + p (update when a value of an element increases).

It is assumed that an initial state of the array b is as indicated in Step S60. In the initial state of the array b, b[0] = 0, and all other elements are set to “-∞”.

In a case where a buy order of which the number of orders is four and a price is eight (ten thousand yen, omitted below) is accepted, the state of the array b is as indicated in Step S61. Because the array b[0 + 4] = -∞ and b[0] + p = 8, the array b[0 + 4] < b[0] + p. Therefore, the existing device sets the array b[0 + 4] = 8.

In a case where a buy order of which the number of orders is two and a price is five is accepted, the state of the array b is as indicated in Step S62. Because the array b[0 + 2] = -∞ and b[0] + p = 5, the array b[0 + 2] < b[0] + p. Therefore, the existing device sets the array b[0 + 2] = 5. Because the array b[4 + 2] = -∞ and b[4] + p = 13, the array b[4 + 2] < b[4] + p. Therefore, the existing device sets the array b[4 + 2] = 13.

In a case where a buy order of which the number of orders is six and a price is 17 is accepted, the state of the array b is as indicated in Step S63. Because the array b[0 + 6] = -∞ and b[0] + p = 17, the array b[0 + 6] < b[0] + p. Therefore, the existing device sets the array b[0 + 6] = 17.

Because the array b[2 + 6] = -∞ and b[2] + p = 22, the array b[2 + 6] < b[2] + p. Therefore, the existing device sets the array b[2 + 6] = 22. Because the array b[4 + 6] = -∞ and b[4] + p = 25, the array b[4 + 6] < b[4] + p. Therefore, the existing device sets the array b[4 + 6] = 25.

Because the array b[6 + 6] = -∞ and b[6] + p = 30, the array b[6 + 6] < b[6] + p. Therefore, the existing device sets the array b[6 + 6] = 30.

Here, the existing device compares the array a described with reference to FIGS. 11 and 12 and the array b described with reference to FIG. 13, and identifies the maximum execution quantity that may be matched.

The description proceeds to FIG. 14. The existing device scans the array a of the sell order and the array b of the buy order for each index, and calculates the maximum index i that satisfies a[i] ≤ b[i] as the maximum execution quantity. In the example illustrated in FIG. 14, the maximum index among the indexes that satisfy a[i] ≤ b[i] is the index i = 10, the existing device calculates the maximum execution quantity as “10”.

Meanwhile, the existing device may identify an order to be an execution target by registering, for each index, auxiliary information indicating an order acceptance sequence (order sequence) and a volume (the number of orders). Processing according to the existing technology (processing using an index) will be described with reference to FIGS. 15 and 16.

FIG. 15 will be described. It is assumed that the initial state of the array a is as indicated in Step S70. In the initial state of the array a, a[0] = 0, and all other elements are set to “∞”.

In a case where a sell order of which the number of orders is three and a price is six is accepted first (order acceptance sequence = 1), the state of the array a is as indicated in Step S71. As in Step S51 in FIG. 11, the existing device sets a[0 + 3] = 6. Furthermore, the existing device registers auxiliary information sub1-3 to the index i = 3. A sequence (denoted by “seq.” in the drawings) “1” and a volume “3 (price 6)” are set to the auxiliary information sub1-3.

Subsequently (order acceptance sequence = 2), in a case where a sell order of which the number of orders is two and a price is five is accepted, the state of the array a is as indicated in Step S72. As in Step S52 in FIG. 11, the existing device sets a[0 + 2] = 5. The existing device registers auxiliary information sub1-2 to the index i = 2. A sequence “2” and a volume “2 (price 5)” are set to the auxiliary information sub1-2.

As in Step S52 in FIG. 11, the existing device sets a[3 + 2] = 11. The existing device registers auxiliary information sub1-5 to the index i = 5. A sequence “2” and a volume “2 (price 5)” are set to the auxiliary information sub1-5.

The existing device repeatedly executes the processing described above each time when a sell order is accepted.

Although illustration is omitted, also in the case of accepting a buy order, the existing device sets a price to the element of the array b, and registers auxiliary information to an index as in FIG. 15. Processing for setting a price to the element of the array b by the existing device is similar to that in FIG. 13.

Processing for identifying orders to be execution targets by the existing device will be described with reference to FIG. 16. After calculating the execution quantity, the existing device identifies orders to be execution targets based on the auxiliary information set to the array a. In a case where an execution is made with the execution quantity i₀, the existing device sets an initial value of the index as i = i₀ and repeatedly executes the following processing until i = 0 is satisfied.

The processing repeated by the existing device is processing indicated below. The existing device sets an order of a[i] corresponding to the index i as an execution target. Next, the existing device identifies a volume α included in auxiliary information set to a[i] and updates the index i according to i = i - α.

Based on the array a in FIG. 16, processing for identifying sell orders to be executed by the existing device will be described. It is assumed that i₀ = 5. The existing device sets an order corresponding to the auxiliary information sub1-5 set to the index i = 5 corresponding to the execution quantity “5” as an execution target. The existing device acquires a volume α = 2 included in the auxiliary information sub1-5, and updates the index i to the index i = 5 - 2 = 3.

The existing device sets an order corresponding to the auxiliary information sub1-3 set to the index i = 3 as an execution target. The existing device acquires a volume α = 3 included in the auxiliary information sub1-3, and updates the index i to the index i = 3 - 3 = 0. Because the index i = 0, the existing device ends the processing.

According to the processing described above, the existing device identifies “the sell order of which the number of orders is three and the price is six” and “the sell order of which the number of orders is two and the price is five” described with reference to FIG. 15 as execution targets. Although illustration is omitted, the existing device also executes the processing corresponding to FIG. 16 on the array b, and identifies buy orders to be execution targets.

International Publication Pamphlet No. WO 2020/179070 and International Publication Pamphlet No. WO 2020/179072 are disclosed as related art.

### SUMMARY

According to an aspect of the embodiment, a non-transitory computer-readable recording medium stores a program for causing a computer to execute a process, the process includes generating, based on order information in which a unit price per stock, a minimum execution quantity that corresponds to a lower limit constraint, and a maximum execution quantity that corresponds to a first upper limit constraint are set, a first graph which has a plurality of nodes and in which the lower limit constraint and the first upper limit constraint are set to an edge that connects each node, generating a second graph by reducing the lower limit constraint and the first upper limit constraint set to the edge in the first graph to a second upper limit constraint only, setting a flow rate on each edge in the second graph by solving a maximum flow problem of the second graph, converting the flow rate set to each edge in the second graph into a flow rate set to each edge in the first graph, and identifying an execution price based on the flow rate set to each edge in the first graph.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a network flow algorithm;

FIG. 2 is a diagram illustrating a method of reducing a problem of a graph in which upper limit constraints and lower limit constraints are set to a problem of a graph with upper limit constraints only;

FIG. 3 is a diagram illustrating processing of an information processing apparatus according to an embodiment;

FIG. 4 is a diagram illustrating a functional configuration of the information processing apparatus according to the embodiment;

FIG. 5 is a diagram illustrating an example of a data structure of a sell order table;

FIG. 6 is a diagram illustrating an example of a data structure of a buy order table;

FIG. 7 is a flowchart illustrating a processing procedure of the information processing apparatus according to the embodiment;

FIG. 8 is a flowchart illustrating a processing procedure of graph generation processing;

FIG. 9 is a diagram illustrating an example of a hardware configuration of a computer that implements functions similar to those of the information processing apparatus according to the embodiment;

FIG. 10 is a diagram illustrating matching between sell orders and buy orders;

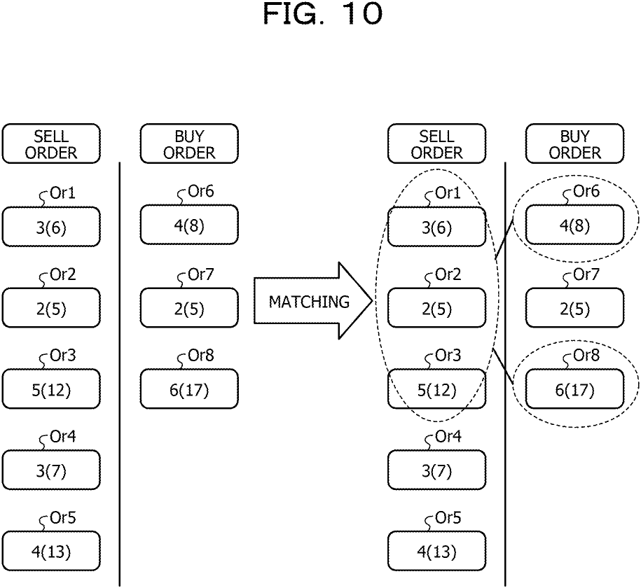

FIG. 11 is a diagram (1) for describing an existing technology;

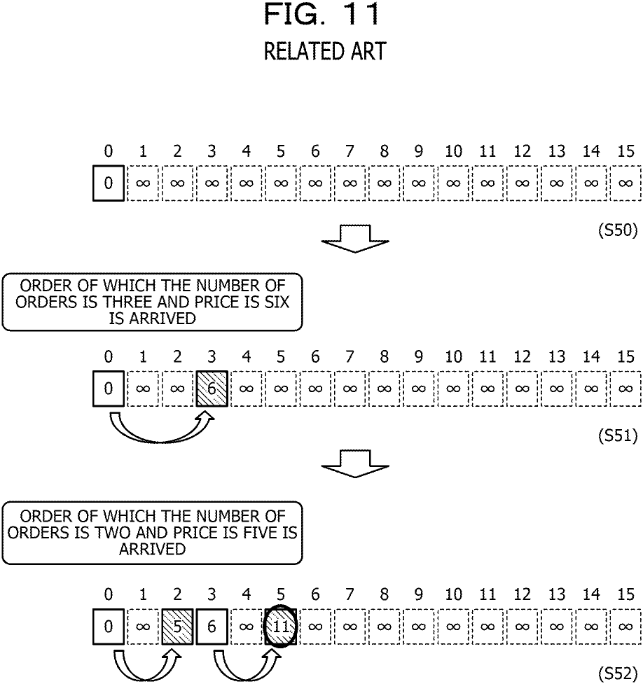

FIG. 12 is a diagram (2) for describing the existing technology;

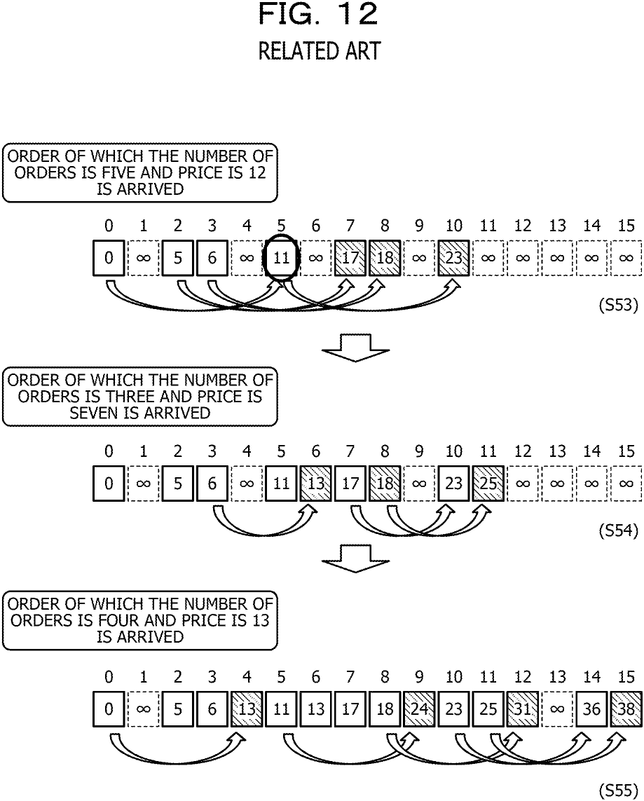

FIG. 13 is a diagram (3) for describing the existing technology;

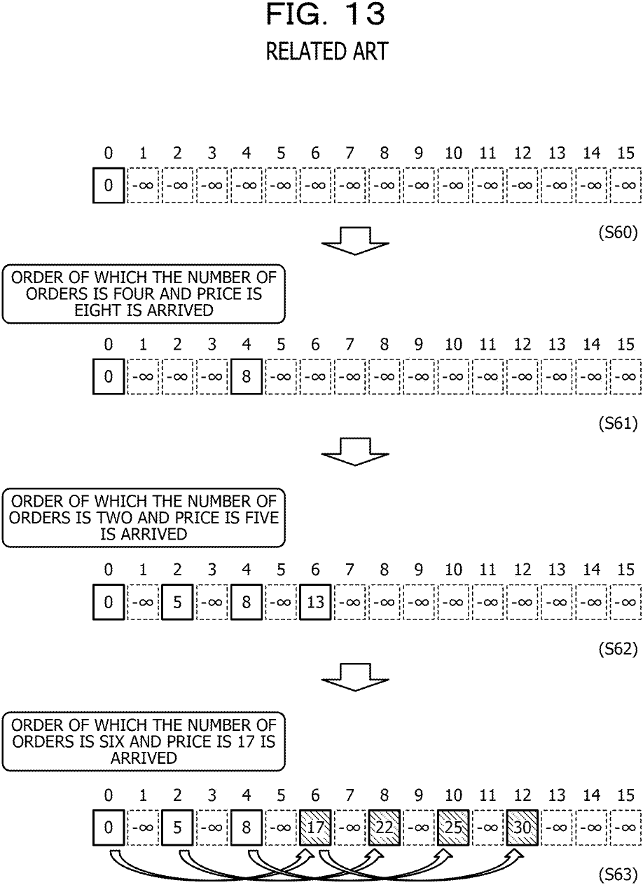

FIG. 14 is a diagram (4) for describing the existing technology;

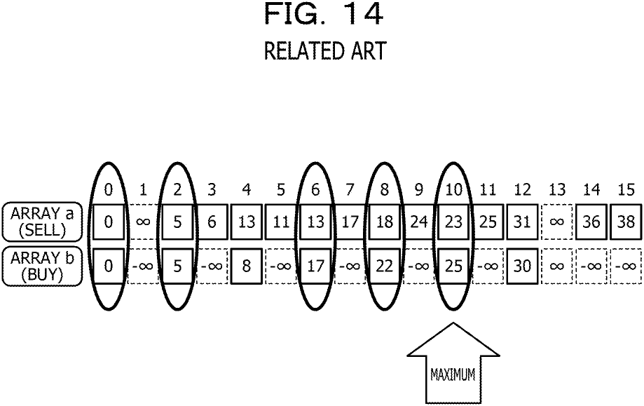

FIG. 15 is a diagram (5) for describing the existing technology; and

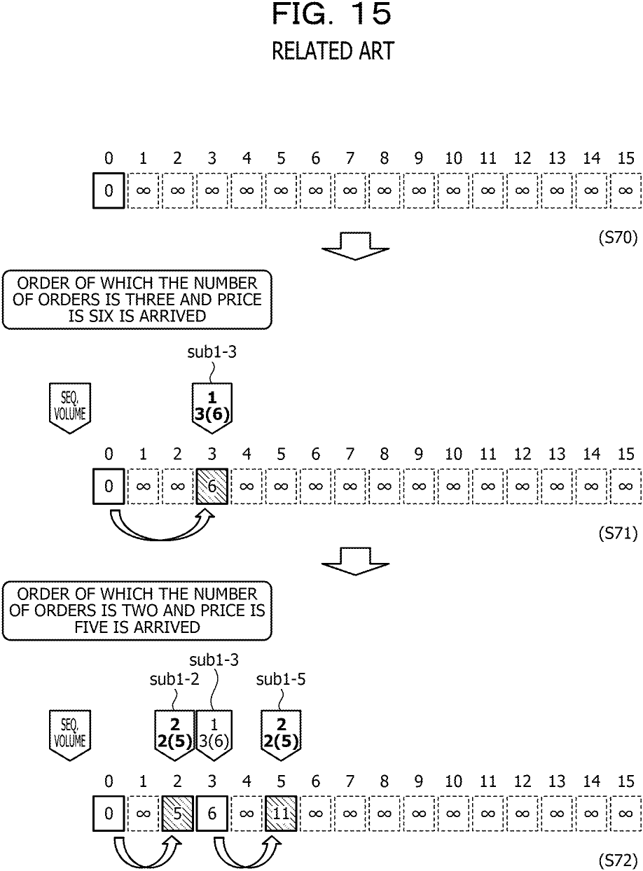

FIG. 16 is a diagram (6) for describing the existing technology.

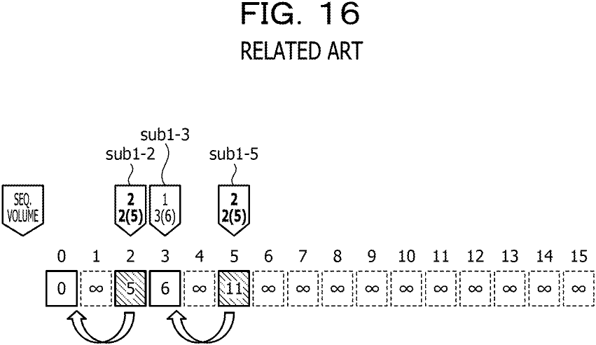

### DESCRIPTION OF EMBODIMENT

In the existing technology described above, since a memory area is used for each total number of orders, and processing for scanning the entire memory area occurs at each time when an order arrives, there is a problem that a memory usage and a calculation amount increase.

Hereinafter, an embodiment of an execution method and an information processing apparatus disclosed in the present application will be described in detail with reference to the drawings. Note that the embodiment does not limit the present disclosure.

### Embodiment

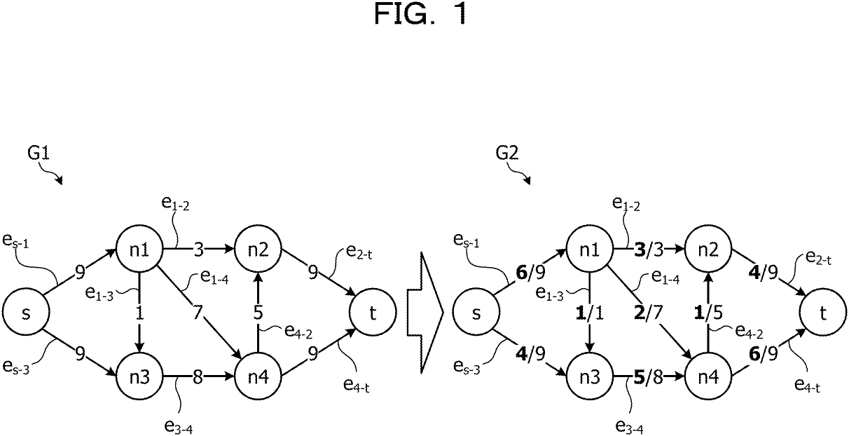

Before describing the information processing apparatus of the embodiment, an example of an algorithm of a network flow will be described. FIG. 1 is a diagram illustrating the algorithm of the network flow. For example, the following problem is referred to as a maximum flow problem (maximum flow rate problem) of the network flow. In the following description, the network flow is referred to as “graph”.

Problem: It is desired to allow as much water as possible to flow along edges of the graph from a vertex node s (source) to a vertex node t (sink). Note that a maximum capacity for water flow is set to each edge. Find how much water is allowed to flow to which edge to allow the most water to flow from the vertex node s to the vertex node t.

For example, a graph G1 in FIG. 1 includes the vertex node s, the vertex node t, and nodes n1, n2, n3, and n4. A maximum capacity “9” is set to an edge eₛ₋₁ between the vertex node s and the node n1. A maximum capacity “9” is set to an edge eₛ₋₃ between the vertex node s and the node n3. A maximum capacity “1” is set to an edge e₁-₃ between the node n1 and the node n3.

A maximum capacity “3” is set to an edge e₁₋₂ between the node n1 and the node n2. A maximum capacity “7” is set to an edge e₁₋₄ between the node n1 and the node n4. A maximum capacity “8” is set to an edge e₃₋₄ between the node n3 and the node n4. A maximum capacity “5” is set to an edge e₄₋₂ between the node n4 and the node n2.

A maximum capacity “9” is set to an edge e₂₋ₜ between the node n2 and the vertex node t. A maximum capacity “9” is set to an edge e₄₋ₜ between the node n4 and the vertex node t.

For example, when an amount of water flowing out from the vertex node s is assumed to be “10” and the graph G1 is solved, a flow rate of each edge is as indicated in a graph G2. The flow rate of the edge eₛ₋₁ is “6”. The flow rate of the edge eₛ₋₃ is “4”. The flow rate of the edge e₁₋₃ is “1”. The flow rate of the edge e₁₋₂ is “3”. The flow rate of the edge e₁₋₄ is “2”. The flow rate of the edge e₃₋₄ is “5”. The flow rate of the edge e₄₋₂ is “1”. The flow rate of the edge e₂₋ₜ is “4”. The flow rate of the edge e₄₋ₜ is “6”.

Meanwhile, in the graph G1 illustrated in FIG. 1, only the maximum capacity corresponding to the upper limit constraint is set to each edge, but a lower limit constraint such as a minimum capacity may be set. A problem of a graph in which upper limit constraints and lower limit constraints are set may be reduced to a problem of a graph with upper limit constraints only by processing as described below.

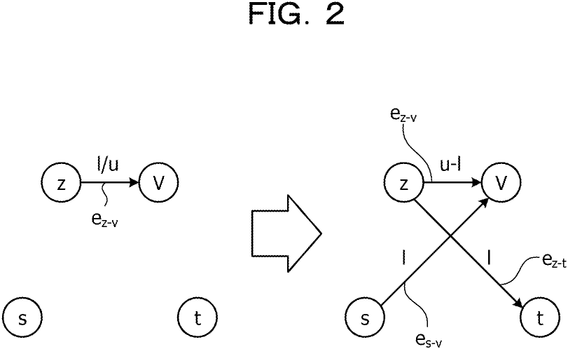

FIG. 2 is a diagram illustrating a method of reducing a problem of a graph in which upper limit constraints and lower limit constraints are set to a problem with upper limit constraints only. In FIG. 2, description will be given by using the vertex node s, the vertex node t, a node z, and a node v. An upper limit constraint “u” and a lower limit constraint “I” are set to an edge e_{z-v} between the node z and the node v.

For example, by executing the following Steps S1 to S3, the problem of a graph in which upper limit constraints and lower limit constraints are set is reduced to a problem of a graph with upper limit constraints only.

S1: Set the edge e_{z-v} to an edge with an upper limit constraint “u - l” and a lower limit constraint “0”.

S2: Provide the edge e_{z-t} from the node z to the vertex node t. Furthermore, provide an edge eₛ₋ᵥ from the vertex node s to the node v. Furthermore, an upper limit constraint “I” is set to the edge e_{z-t} and the edge eₛ₋ᵥ.

S3: When the edges added based on the lower limit constraint (for example, the edge e_{z-t} and the edge eₛ₋ᵥ) have the maximum flow rate in a case of the maximum flow, it may be said that a flow that satisfies the lower limit constraint exists. On the other hand, when the edges added based on the lower limit constraint (for example, the edge e_{z-t} and the edge eₛ₋ᵥ) don’t have the maximum flow rate, a flow that satisfies the lower limit constraint does not exist.

Subsequently, the processing of the information processing apparatus according to the embodiment will be described. The information processing apparatus generates, based on buy orders and sell orders in securities trading, a first graph in which upper limit constraints and lower limit constraints are set. The information processing apparatus generates a second graph corresponding to a problem with upper limit constraints only, which is reduced from a problem of the first graph in which upper limit constraints and lower limit constraints are set. After solving a maximum flow problem of the second graph, the information processing apparatus converts a solution (flow rate of each edge) obtained in the second graph into a flow rate of each edge in the first graph, and determines an execution price from the flow rate of each edge in the first graph.

With this configuration, it is possible to reduce a calculation amount and a memory amount compared to the solution by the dynamic programming described in the existing technology. For example, in the existing technology, it is needed to prepare a memory area corresponding to an array for the total number of stocks, and scan the array of the memory each time one order is processed. On the other hand, in the information processing apparatus of the embodiment, the execution price may be determined only by preparing as many nodes as the number of orders and the number of prices.

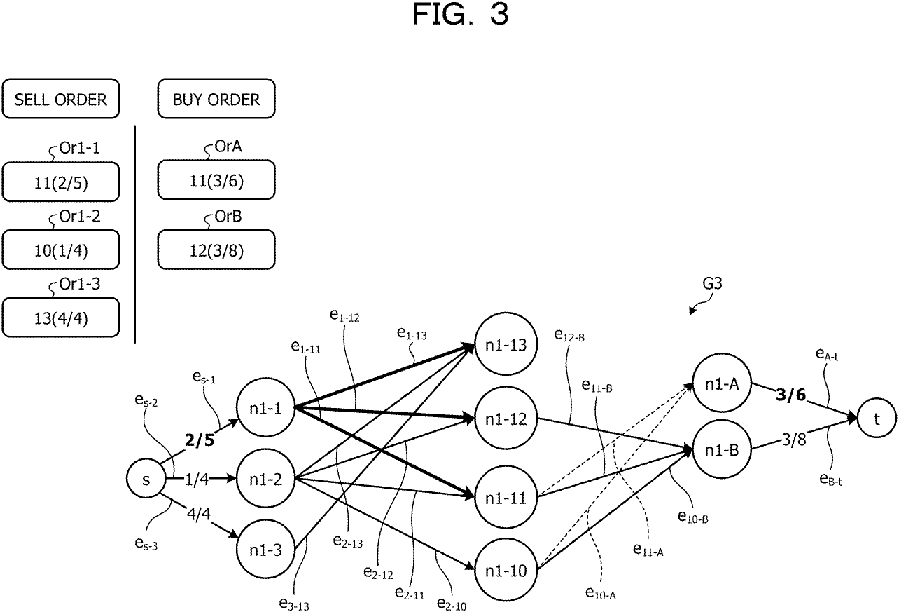

FIG. 3 is a diagram illustrating processing of the information processing apparatus according to the embodiment. In the embodiment, the following graph is assumed in which orders and designated prices are divided into sell orders and buy orders. Vertices of the graph include a node corresponding to a source (s) and a node corresponding to a sink (t). The vertices include a vertex corresponding to each sell order. The vertices include a vertex corresponding to each buy order. The vertices include a vertex corresponding to each price value.

In the following description, the node corresponding to the source (s) will be referred to as “vertex node s”. The node corresponding to the sink (t) is referred to as “vertex node t”. The vertex corresponding to each sell order is referred to as “sell order node”. The vertex corresponding to each buy order is referred to as “buy order node”. The vertex corresponding to each price value is referred to as “price node”. Note that the vertex node s, the vertex node t, the sell order node, the buy order node, and the price node are collectively referred to as “nodes” as appropriate.

In the example illustrated in FIG. 3, orders Or1-1, Or1-2, and Or1-3 exist as sell orders. The Order Or1-1 is an order with a price (unit price per stock, hereinafter the same) of “11”, the minimum execution quantity of “2” for the price, and the maximum execution quantity of “5” for the price. The Order Or1-2 is an order with a price of “10”, the minimum execution quantity of “1” for the price, and the maximum execution quantity of “4” for the price. The Order Or1-3 is an order with a price of “13”, the minimum execution quantity of “4” for the price, and the maximum execution quantity of “4” for the price.

Orders OrA and OrB exist as buy orders. The Order OrA is an order with a price of “11”, the minimum execution quantity of “3” for the price, and the maximum execution quantity of “6” for the price. The Order OrB is an order with a price of “12”, the minimum execution quantity of “3” for the price, and the maximum execution quantity of “8” for the price.

For example, the information processing apparatus sets each node (vertex) as described below for the orders described above. The information processing apparatus sets the vertex node s and the vertex node t in a graph G3. The information processing apparatus sets a sell order node n1-1 corresponding to the order Or1-1 in the graph G3. The information processing apparatus sets a sell order node n1-2 corresponding to the order Or1-2 in the graph G3. The information processing apparatus sets a sell order node n1-3 corresponding to the order Or1-3 in the graph G3.

The information processing apparatus sets a price node n1-13 corresponding to the price “13” of the order Or1-3 in the graph G3. The information processing apparatus sets a price node n1-12 corresponding to the price “12” of the order OrB in the graph G3. The information processing apparatus sets a price node n1-11 corresponding to the price “11” of the order Or1-1 and the order OrA in the graph G3. The information processing apparatus sets a price node n1-10 corresponding to the price “10” of the order Or1-2 in the graph G3.

The information processing apparatus sets a buy order node n1-A corresponding to the order OrA in the graph G3. The information processing apparatus sets a buy order node n1-B corresponding to the order OrB in the graph G3.

After setting each node as described above, the information processing apparatus executes the following processing to provide edges. It is assumed that all the respective edges are directed edges. The information processing apparatus provides an edge from the vertex node s to each sell order node, with the minimum execution quantity of the order as a lower limit and the maximum execution quantity of the order as an upper limit.

In the graph of FIG. 3, the information processing apparatus provides an edge e₅₋₁ from the vertex node s to the sell order node n1-1. Based on the order Or1-1, the information processing apparatus sets the lower limit constraint to “2” and sets the upper limit constraint to “5” for the edge eₛ₋₁.

The information processing apparatus provides an edge eₛ₋₂ from the vertex node s to the sell order node n1-2. Based on the order Or1-2, the information processing apparatus sets the lower limit constraint to “1” and sets the upper limit constraint to “4” for the edge eₛ₋₂.

The information processing apparatus provides an edge eₛ₋₃ from the vertex node s to the sell order node n1-3. Based on the order Or1-3, the information processing apparatus sets the lower limit constraint to “4” and sets the upper limit constraint to “4” for the edge e₅₋₃.

Subsequently, the information processing apparatus provides an edge from each sell order node to the price nodes when an execution at that price is possible. For example, the information processing apparatus identifies a price node corresponding to a price equal to or higher than a designated price corresponding to a certain sell order node, and provides an edge between the certain sell order node and the identified price node.

For example, the price of the order Or1-1 corresponding to the sell order node n1-1 is “11”. Therefore, the information processing apparatus identifies the price nodes n1-13, n1-12, and n1-11 corresponding to the prices equal to or higher than the price “11” as price nodes to which edges are to be provided from the sell order node n1-1.

The information processing apparatus provides an edge e₁₋₁₃ from the sell order node n1-1 to the price node n1-13. The information processing apparatus provides an edge e₁₋₁₂ from the sell order node n1-1 to the price node n1-12. The information processing apparatus provides an edge e₁₋₁₁ from the sell order node n1-1 to the price node n1-11. Since there is no capacity limit for the edge e₁₋₁₁ to the edge e₁₋₁₃, the information processing apparatus sets the upper limit constraint of the edge e₁₋₁₁ to the edge e₁₋₁₃ to infinity.

The price of the order Or1-2 corresponding to the sell order node n1-2 is “10”. Therefore, the information processing apparatus identifies the price nodes n1-13, n1-12, n1-11, and n1-10 corresponding to the prices equal to or higher than the price “10” as price nodes to which edges are to be provided from the sell order node n1-2.

The information processing apparatus provides an edge e₂₋₁₃ from the sell order node n1-2 to the price node n1-13. The information processing apparatus provides an edge e₂₋₁₂ from the sell order node n1-2 to the price node n1-12. The information processing apparatus provides an edge e₂₋₁₁ from the sell order node n1-2 to the price node n1-11. The information processing apparatus provides an edge e₂₋₁₀ from the sell order node n1-2 to the price node n1-10. Since there is no capacity limit for the edge e₂₋₁₀ to the edge e₂₋₁₃, the information processing apparatus sets the upper limit constraint of the edge e₂₋₁₀ to the edge e₂₋₁₃ to infinity.

The price of the order Or1-3 corresponding to the sell order node n1-3 is “13”. Therefore, the information processing apparatus identifies the price node n1-13 corresponding to the price equal to or higher than the price “13” as a price node to which an edge is to be provided from the sell order node n1-3.

The information processing apparatus provides an edge e₃₋₁₃ from the sell order node n1-3 to the price node n1-13.

Subsequently, the information processing apparatus provides an edge from the price nodes to each buy order node when an execution at that price is possible. For example, the information processing apparatus identifies a price node corresponding to a price equal to or lower than a designated price corresponding to a certain buy order node, and provides an edge between the certain buy order node and the identified price node.

For example, the price of the order OrA corresponding to the buy order node n1-A is “11”. Therefore, the information processing apparatus identifies the price nodes n1-11 and n1-10 corresponding to the prices equal to or lower than the price “11” as price nodes from which edges are to be provided to the buy order node n1-A.

The information processing apparatus provides an edge e_{11-A} from the price node n1-11 to the buy order node n1-A. The information processing apparatus provides an edge e_{10-A} from the price node n1-10 to the buy order node n1-A. Since there is no capacity limit for the edge e₁₀-_{A} and the edge e_{11-A}, the information processing apparatus sets the upper limit constraint of the edge e_{10-A} and the edge e_{11-A} to infinity.

For example, the price of the Order OrB corresponding to the buy order node n1-B is “12”. Therefore, the information processing apparatus identifies the price nodes n1-12, n1-11, and n1-10 corresponding to the prices equal to or lower than the price “12” as price nodes from which edges are to be provided to the buy order node n1-B.

The information processing apparatus provides an edge e_{12-B} from the price node n1-12 to the buy order node n1-B. The information processing apparatus provides an edge e_{11-B} from the price node n1-11 to the buy order node n1-B. The information processing apparatus provides an edge e_{10-B} from the price node n1-10 to the buy order node n1-B. Since there is no capacity limit for the edge e_{10-B} to the edge e_{12-B}, the information processing apparatus sets the upper limit constraint of the edge e_{10-B} to the edge e_{12-B} to infinity.

Subsequently, the information processing apparatus provides an edge e_{A-t} from the buy order node n1-A to the vertex node t. Based on the Order OrA, the information processing apparatus sets the lower limit constraint to “3” and sets the upper limit constraint to “6” for the edge e_{A-t}.

The information processing apparatus provides an edge e_{B-t} from the buy order node n1-B to the vertex node t. Based on the Order OrB, the information processing apparatus sets the lower limit constraint to “3” and sets the upper limit constraint to “8” for the edge e_{B}-ₜ.

The graph G3 is generated by the information processing apparatus executing the processing described above based on the sell orders and the buy orders. The graph G3 includes the lower limit constraints in addition to the upper limit constraints of a normal graph.

The information processing apparatus removes the lower limit constraints of the graph G3 to generate a graph G3′ by executing the processing described with reference to FIG. 2 on the graph G3. Although illustration of the graph G3′ is omitted, the graph G3′ is a graph corresponding to a problem with upper limit constraints only, which is reduced from a problem of the graph G3 in which upper limit constraints and the lower limit constraints are set.

After solving a maximum flow problem of the graph G3′, the information processing apparatus converts a solution (flow rate of each edge) obtained in the graph G3′ into a flow rate of each edge in the graph G3, and determines an execution price from the flow rate of each edge in the graph G3. The information processing apparatus may use any existing technology to solve the maximum flow problem of the graph G3′.

For example, it is assumed that, as a result of the processing of the information processing apparatus described above, in the graph G3, “3” is set as a flow rate of the edge eₛ₋₁ connecting the vertex node s and the sell order node n1-1, and “3” is set as a flow rate of the edge e₁₋₁₃ connecting the sell order node n1-1 and the price node n1-13. In this case, the information processing apparatus identifies a unit price of the sell order Or1-1 as “13” and the execution quantity as “3”.

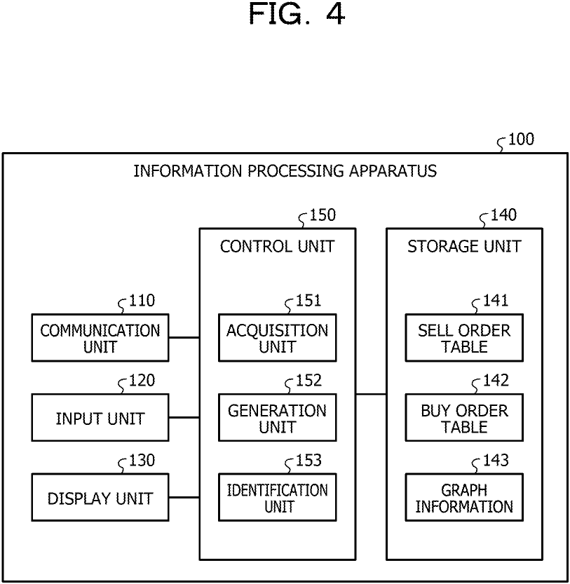

Next, a configuration example of the information processing apparatus according to the embodiment will be described. FIG. 4 is a diagram illustrating a functional configuration of the information processing apparatus according to the embodiment. As illustrated in FIG. 4, an information processing apparatus 100 includes a communication unit 110, an input unit 120, a display unit 130, a storage unit 140, and a control unit 150.

The communication unit 110 executes data communication with an external device or the like (not illustrated). For example, the communication unit 110 is implemented by a network interface card (NIC) or the like.

The input unit 120 is implemented by using an input device such as a keyboard or a mouse, and inputs various types of information to the control unit 150 in response to an input operation by a user.

The display unit 130 is implemented by a display device such as a liquid crystal display or the like. The display unit 130 displays a display screen generated by the control unit 150.

The storage unit 140 is implemented by, for example, a semiconductor memory element such as a flash memory, or a storage device such as a hard disk or an optical disk. The storage unit 140 includes a sell order table 141, a buy order table 142, and graph information 143.

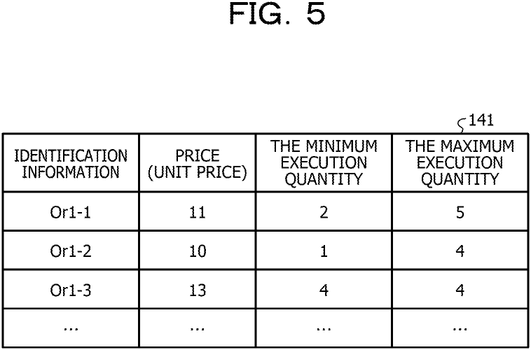

The sell order table 141 is a table that holds information regarding sell orders. FIG. 5 is a diagram illustrating an example of a data structure of the sell order table 141. As illustrated in FIG. 5, this sell order table 141 associates identification information, a price (unit price per stock), the minimum execution quantity, and the maximum execution quantity. The identification information in FIG. 5 is information that identifies a sell order. The description regarding the minimum execution quantity and the maximum execution quantity is similar to the description described above.

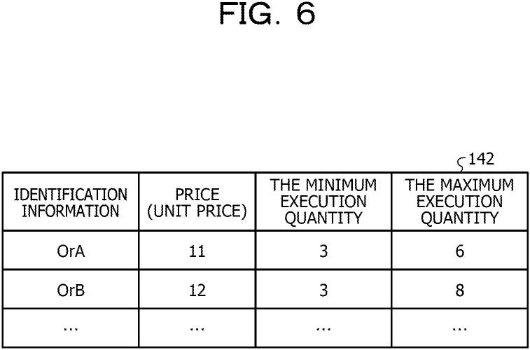

The buy order table 142 is a table that holds information regarding buy orders. FIG. 6 is a diagram illustrating an example of a data structure of the buy order table. As illustrated in FIG. 6, this buy order table 142 associates identification information, a price (unit price per stock), the minimum execution quantity, and the maximum execution quantity. The identification information in FIG. 6 is information that identifies a buy order. The description regarding the minimum execution quantity and the maximum execution quantity is similar to the description described above.

The graph information 143 is information of a graph in which a plurality of nodes are connected by directed edges, as described with reference to FIG. 3.

The description returns to FIG. 4. The control unit 150 includes an acquisition unit 151, a generation unit 152, and an identification unit 153. The control unit 150 is implemented by a central processing unit (CPU) or a micro processing unit (MPU). Furthermore, the control unit 150 may be executed by, for example, an integrated circuit such as an application specific integrated circuit (ASIC) or a field programmable gate array (FPGA).

The acquisition unit 151 acquires data of the sell order table 141 from an external device or the like, and registers the acquired sell order table 141 in the storage unit 140. The acquisition unit 151 acquires data of the buy order table 142 from an external device or the like, and registers the acquired buy order table 142 in the storage unit 140.

The generation unit 152 generates the graph information 143 based on data of sell orders registered in the sell order table 141 and data of buy orders registered in the buy order table 142. The graph information 143 corresponds to the graph G3 described with reference to FIG. 3. The generation unit 152 sets nodes and connects the nodes by directed edges, as described with reference to FIG. 3. The graph G3 includes the lower limit constraints in addition to the upper limit constraints of a normal graph. Another processing executed by the generation unit 152 is similar to the processing described with reference to FIG. 3.

The identification unit 153 identifies an execution price of each order based on the graph information 143. For example, the identification unit 153 removes the lower limit constraints of the graph G3 to generate the graph G3′ by executing the processing described with reference to FIG. 2 on the graph G3. The graph G3′ is a graph corresponding to a problem with the upper limit constraints only, which is reduced from the problem of the graph G3 in which the upper limit constraints and the lower limit constraints are set.

For example, by setting a value obtained by subtracting a lower limit constraint from an upper limit constraint of a target edge connecting a first node and a second node in the graph G3 to a new upper limit constraint of the target edge and removing the lower limit constraint of the target edge, the identification unit 153 reduces the lower limit constraint and the upper limit constraint to an upper limit constraint only. In FIG. 3, it is assumed that the first node is the vertex node s, and the second node is the sell order node n1-1. In this case, the identification unit 153 sets a value “3” obtained by subtracting the lower limit constraint “2” from the upper limit constraint “5” of the edge eₛ₋₁ as an upper limit constraint “3” of the edge eₛ₋₁, and sets the lower limit constraint to “0”.

The identification unit 153 sets a value corresponding to the lower limit constraint removed from the target edge to an edge connecting a third node and the first node in the graph G3, and sets the value corresponding to the lower limit constraint removed from the target edge to an edge connecting a fourth node and the second node in the graph G3. Description is given with reference to FIG. 2. The identification unit 153 sets the value of the lower limit constraint “2” obtained by the subtraction in the processing described above as a value of the upper limit constraint of the edge eₛ₋ᵥ connecting the vertex node s and the node v. The identification unit 153 sets the value of the lower limit constraint “2” obtained by the subtraction in the processing described above as a value of the upper limit constraint of an edge e_{z-t} connecting the node z and the vertex node t.

The identification unit 153 generates the graph G3′ obtained by removing the lower limit constraints of the graph G3 by repeatedly executing the processing described above for each edge to which the upper limit constraint and the lower limit constraint are set.

Subsequently, the identification unit 153 identifies a flow rate of each edge in the graph G3′ by solving the maximum flow problem of the graph G3′. The identification unit 153 converts a solution (flow rate of each edge) obtained in the graph G3′ into a flow rate of each edge in the graph G3, and determines an execution price from the flow rate of each edge in the graph G3. For example, the identification unit 153 identifies the flow rate of each edge in the graph G3 by adding, to the flow rate set to each edge of the graph G3′, each value of the lower limit constraint subtracted when the graph G3 is converted into the graph G3′.

For example, it is assumed that, as a result of the processing described above, in the graph G3, the identification unit 153 identifies the flow rate of the edge eₛ₋₁ connecting the vertex node s and the sell order node n1-1 as “3”, and identifies the flow rate of the edge e₁₋₁₃ connecting the sell order node n1-1 and the price node n1-13 as “3”. In this case, the identification unit 153 identifies the price of the sell order Or1-1 as “13” and the execution quantity as “3”.

The identification unit 153 outputs, to the display unit 130, an identification result of the price and the execution quantity for each sell order and each buy order, and causes the display unit 130 to display the identification result. The identification unit 153 may notify an external device or the like of the identification result.

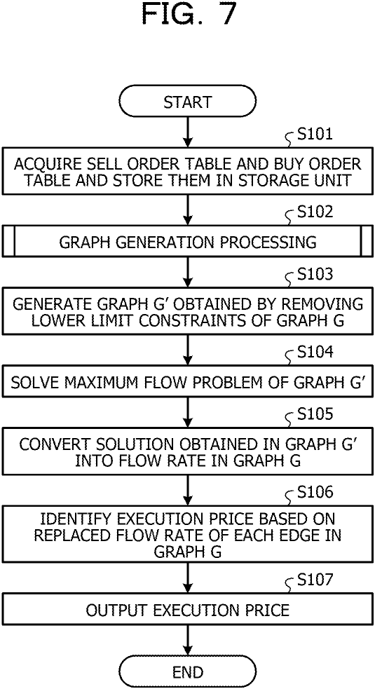

Next, an example of a processing procedure of the information processing apparatus 100 according to the embodiment will be described. FIG. 7 is a flowchart illustrating the processing procedure of the information processing apparatus 100 according to the embodiment. As illustrated in FIG. 7, the acquisition unit 151 of the information processing apparatus 100 acquires the sell order table 141 and the buy order table 142, and registers them in the storage unit 140 (Step S101).

The generation unit 152 of the information processing apparatus 100 executes graph generation processing (Step S102). The identification unit 153 of the information processing apparatus 100 generates a graph G′ obtained by removing lower limit constraints of a graph G (Step S103).

The identification unit 153 solves a maximum flow problem of the graph G′ (Step S104). The identification unit 153 converts a solution (flow rate of each edge) obtained in the graph G′ into a flow rate of each edge in the graph G (Step S105). The identification unit 153 identifies an execution price based on the flow rate of each edge in the graph G (Step S106).

The identification unit 153 outputs the execution price (Step S107).

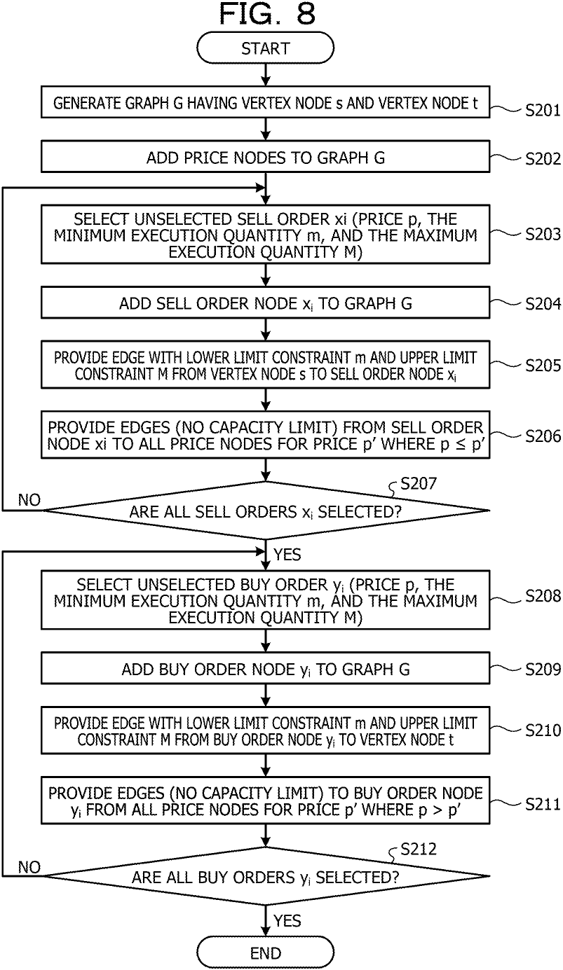

Next, a processing procedure of the graph generation processing indicated in Step S102 will be described. FIG. 8 is a flowchart illustrating the processing procedure of the graph generation processing. As illustrated in FIG. 8, the generation unit 152 of the information processing apparatus 100 generates the graph G having the vertex node s (source) and the vertex node t (sink) (Step S201).

The generation unit 152 adds price nodes to the graph G (Step S202). The generation unit 152 selects an unselected sell order xᵢ (price p, the minimum execution quantity m, and the maximum execution quantity M) (Step S203). The generation unit 152 adds a sell order node xᵢ to the graph G (Step S204). The generation unit 152 provides an edge with a lower limit constraint m and an upper limit constraint M from the vertex node s to the sell order node xᵢ (Step S205). The generation unit 152 provides edges (no capacity limit) from the sell order node xᵢ to all price nodes for price p′ where p ≤ p′ (Step S206).

In a case where some sell orders xᵢ are not yet selected (Step S207, No), the generation unit 152 proceeds to Step S203. On the other hand, in a case where all the sell orders xᵢ are selected (Step S207, Yes), the generation unit 152 proceeds to Step S208.

The generation unit 152 selects an unselected buy order yᵢ (price p, the minimum execution quantity m, and the maximum execution quantity M) (Step S208). The generation unit 152 adds a buy order node yᵢ to the graph G (Step S209). The generation unit 152 provides an edge with a lower limit constraint m and an upper limit constraint M from the buy order node yᵢ to the vertex node t (Step S210). The generation unit 152 provides edges (no capacity limit) to the buy order node yᵢ from all price nodes for price p′ where p > p′ (Step S211).

In a case where some buy orders yᵢ are not yet selected (Step S212, No), the generation unit 152 proceeds to Step S208. On the other hand, in a case where all the buy orders yᵢ are selected (Step S212, Yes), the generation unit 152 ends the graph generation processing.

Next, effects of the information processing apparatus 100 according to the embodiment will be described. The information processing apparatus 100 generates, based on buy orders and sell orders in securities trading, a first graph in which upper limit constraints and lower limit constraints are set. The information processing apparatus 100 generates a second graph corresponding to a problem with upper limit constraints only, which is reduced from a problem of the first graph in which upper limit constraints and lower limit constraints are set. After solving a maximum flow problem of the second graph, the information processing apparatus 100 converts a solution (flow rate of each edge) obtained in the second graph into a flow rate of each edge in the first graph, and determines an execution price from the flow rate of each edge in the first graph.

With this configuration, it is possible to reduce a calculation amount and a memory amount compared to the solution by the dynamic programming described in the existing technology. For example, in the existing technology, it is needed to prepare a memory area corresponding to an array for the total number of stocks, and scan the array of the memory each time one order is processed. On the other hand, in the information processing apparatus 100 of the embodiment, the execution price may be determined only by preparing as many nodes as the number of orders and the number of prices.

By setting a value obtained by subtracting a lower limit constraint from an upper limit constraint of a target edge connecting a first node and a second node in the first graph to a new upper limit constraint of the target edge and removing the lower limit constraint of the target edge, the information processing apparatus 100 reduces the lower limit constraint and the upper limit constraint to an upper limit constraint only. Furthermore, the information processing apparatus 100 sets a value corresponding to the lower limit constraint removed from the target edge to an edge connecting a third node and the first node in the first graph, and sets the value corresponding to the lower limit constraint removed from the target edge to an edge connecting a fourth node and the second node in the first graph. With this configuration, it is possible to generate the second graph corresponding to the reduced problem with the upper limit constraints only, and to apply the method for solving the maximum flow problem.

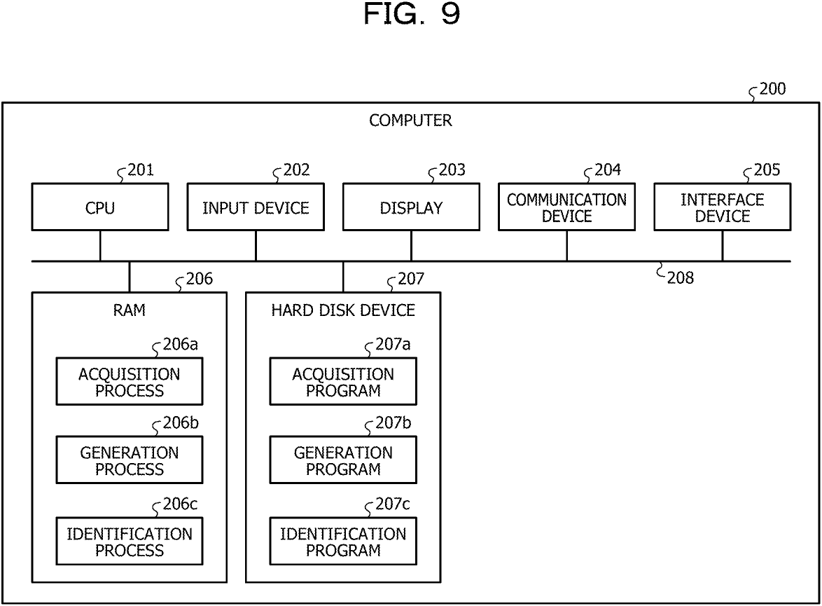

Next, an example of a hardware configuration of a computer that implements functions similar to those of the information processing apparatus 100 indicated in the embodiment described above will be described. FIG. 9 is a diagram illustrating an example of the hardware configuration of the computer that implements the functions similar to those of the information processing apparatus 100 of the embodiment.

As illustrated in FIG. 9, a computer 200 includes a CPU 201 that executes various types of arithmetic processing, an input device 202 that accepts data input from a user, and a display 203. Furthermore, the computer 200 includes a communication device 204 that exchanges data with an external device or the like via a wired or wireless network, and an interface device 205. Furthermore, the computer 200 includes a random access memory (RAM) 206 that temporarily stores various types of information, and a hard disk device 207. Additionally, each of the devices 201 to 207 is coupled to a bus 208.

The hard disk device 207 includes an acquisition program 207a, a generation program 207b, and an identification program 207c. Furthermore, the CPU 201 reads the individual programs 207a to 207c, and loads them into the RAM 206.

The acquisition program 207a functions as an acquisition process 206a. The generation program 207b functions as a generation process 206b. The identification program 207c functions as an identification process 206c.

Processing of the acquisition process 206a corresponds to the processing of the acquisition unit 151. Processing of the generation process 206b corresponds to the processing of the generation unit 152. Processing of the identification process 206c corresponds to the processing of the identification unit 153.

Note that the individual programs 207a to 207c may not necessarily be stored in the hard disk device 207 from the beginning. For example, each of the programs may be stored in a “portable physical medium” to be inserted into the computer 200, such as a flexible disk (FD), a compact disc read only memory (CD-ROM), a digital versatile disc (DVD), a magneto-optical disk, or an integrated circuit (IC) card. Then, the computer 200 may read and execute each of the programs 207a to 207c.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
generating, based on order information in which a unit price per stock, a minimum execution quantity that corresponds to a lower limit constraint, and a maximum execution quantity that corresponds to a first upper limit constraint are set, a first graph which has a plurality of nodes and in which the lower limit constraint and the first upper limit constraint are set to an edge that connects each node;
generating a second graph by reducing the lower limit constraint and the first upper limit constraint set to the edge in the first graph to a second upper limit constraint only;
setting a flow rate on each edge in the second graph by solving a maximum flow problem of the second graph;
converting the flow rate set to each edge in the second graph into a flow rate set to each edge in the first graph; and
identifying an execution price based on the flow rate set to each edge in the first graph.

2. The non-transitory computer-readable recording medium according to claim 1, wherein
the order information includes information regarding a sell order and information regarding a buy order, and
the process further comprises:
generating the first graph, in which a plurality of nodes each of which corresponds to a source, a sink, the sell order, the buy order, or the unit price are included, by setting the lower limit constraint and the upper limit constraint to an edge between each node.

3. The non-transitory computer-readable recording medium according to claim 2, the process further comprising:
reducing the lower limit constraint and the first upper limit constraint to the second upper limit constraint only, by setting a value obtained by subtracting the lower limit constraint from the first upper limit constraint of a target edge that connects a first node and a second node in the first graph as the second upper limit constraint of the target edge and removing the lower limit constraint of the target edge.

4. The non-transitory computer-readable recording medium according to claim 3, the process further comprising:
setting a value that corresponds to the lower limit constraint removed from the target edge to an edge that connects a third node and the first node in the first graph and to an edge that connects a fourth node and the second node in the first graph to generate the second graph.

5. An execution method, comprising:
generating by a computer, based on order information in which a unit price per stock, a minimum execution quantity that corresponds to a lower limit constraint, and a maximum execution quantity that corresponds to a first upper limit constraint are set, a first graph which has a plurality of nodes and in which the lower limit constraint and the first upper limit constraint are set to an edge that connects each node;
generating a second graph by reducing the lower limit constraint and the first upper limit constraint set to the edge in the first graph to a second upper limit constraint only;
setting a flow rate on each edge in the second graph by solving a maximum flow problem of the second graph;
converting the flow rate set to each edge in the second graph into a flow rate set to each edge in the first graph; and
identifying an execution price based on the flow rate set to each edge in the first graph.

6. The execution method according to claim 5, wherein
the order information includes information regarding a sell order and information regarding a buy order, and
the execution method further comprises:
generating the first graph, in which a plurality of nodes each of which corresponds to a source, a sink, the sell order, the buy order, or the unit price are included, by setting the lower limit constraint and the upper limit constraint to an edge between each node.

7. The execution method according to claim 6, further comprising:
reducing the lower limit constraint and the first upper limit constraint to the second upper limit constraint only, by setting a value obtained by subtracting the lower limit constraint from the first upper limit constraint of a target edge that connects a first node and a second node in the first graph as the second upper limit constraint of the target edge and removing the lower limit constraint of the target edge.

8. The execution method according to claim 7, further comprising:
setting a value that corresponds to the lower limit constraint removed from the target edge to an edge that connects a third node and the first node in the first graph and to an edge that connects a fourth node and the second node in the first graph to generate the second graph.

9. An information processing apparatus, comprising:
a memory; and
a processor coupled to the memory and the processor configured to:
generate, based on order information in which a unit price per stock, a minimum execution quantity that corresponds to a lower limit constraint, and a maximum execution quantity that corresponds to a first upper limit constraint are set, a first graph which has a plurality of nodes and in which the lower limit constraint and the first upper limit constraint are set to an edge that connects each node;
generate a second graph by reducing the lower limit constraint and the first upper limit constraint set to the edge in the first graph to a second upper limit constraint only;
set a flow rate on each edge in the second graph by solving a maximum flow problem of the second graph;
convert the flow rate set to each edge in the second graph into a flow rate set to each edge in the first graph; and
identify an execution price based on the flow rate set to each edge in the first graph.

10. The information processing apparatus according to claim 9, wherein
the order information includes information regarding a sell order and information regarding a buy order, and
the processor is further configured to:
generate the first graph, in which a plurality of nodes each of which corresponds to a source, a sink, the sell order, the buy order, or the unit price are included, by setting the lower limit constraint and the upper limit constraint to an edge between each node.

11. The information processing apparatus according to claim 10, wherein
the processor is further configured to:
reduce the lower limit constraint and the first upper limit constraint to the second upper limit constraint only, by setting a value obtained by subtracting the lower limit constraint from the first upper limit constraint of a target edge that connects a first node and a second node in the first graph as the second upper limit constraint of the target edge and removing the lower limit constraint of the target edge.

12. The information processing apparatus according to claim 11, wherein
the processor is further configured to:
set a value that corresponds to the lower limit constraint removed from the target edge to an edge that connects a third node and the first node in the first graph and to an edge that connects a fourth node and the second node in the first graph to generate the second graph.
